(19) United States
(12) Patent Application Publication
(10) Pub. No.: US 2006/0015386 A1
(43) Pub. Date: Jan. 19, 2006

(54) Avoiding conflicting requests for resources or meetings

(76) Inventor: Dennis B. Moore, Hillsborough, CA (US)

Correspondence Address: KENNETH F. KOZIK, ESQ.;HOLLAND & KNIGHT LLP, 10 ST. JAMES AVENUE, BOSTON, MA, 02116, US

(21) Appl. No.: 11/138,993

(22) Filed: May 26, 2005

Related U.S. Application Data
(60) Provisional application No. 60/589,306, filed on Jul. 19, 2004.

(51) Int. Cl. G06Q 10/00

(52) U.S. Cl. 705/8

(57) ABSTRACT

Methods and apparatus, including computer program products, for avoiding scheduling conflicts in resource reservations and meeting reservations. A method includes receiving personal and/or resource data in a meeting appointment form presented by a system, retrieving current schedules for the received personal and/or resource data residing in back end systems, and generating a warning if the received personal and/or resource data conflicts with the current schedules for requested personal and/or resource data.

### CROSS-REFERENCE TO RELATED APPLICATIONS

This application claims priority based on U.S. patent application No. 60/589,306 for AVOIDING CONFLICTING REQUESTS FOR RESOURCES OR MEETINGS, filed Jul. 19, 2004, the disclosure of which is incorporated here by reference in its entirety.

### BACKGROUND

The present invention relates to data processing by digital computer, and more particularly to avoiding conflicting requests for resources or meetings.

In general, calendaring software informs a user what day it is, rings an alarm (or flashes a screen reminder), and/or lines up and schedules events that are to take place. Existing calendaring software applications, such as Microsoft Outlook®, have features that allow computer users to set up an appointment in a calendaring application or application component. The user sets a time for the meeting, optionally selects resources such as a meeting room or equipment to be used, and then optionally selects people to invite to the meeting.

### SUMMARY

The present invention provides methods and apparatus, including computer program products, for avoiding conflicting requests for resources and meetings.

In general, in one aspect, the invention features a method including receiving personal and/or resource data in a meeting appointment form presented by a system, retrieving current schedules for the received personal and/or resource data residing in back end systems, and generating a warning if the received personal and/or resource data conflicts with the current schedules for requested personal and/or resource data.

In embodiments, the form can be displayed on a graphical user interface (GUI). The back end systems can be implemented to include at least one of a calendar server, human resource server, asset management system, service system and maintenance system.

The warning can be implemented to include at least one of a window's status area, a warning icon in the form, a pop-up dialogue describing the conflict, a pop-up dialogue describing the conflict and offering options for resolving the conflict and offering to automatically make changes necessary to resolve the conflict, a highlight to the received personal and/or resource data showing where the conflict is, a window's title bar, an audio indication and a visual indication.

A form of the warning can be user-selected. Retrieving current schedules can include an application programming interface (API) call. Retrieving current schedules can include a web interface. A conflict between the received personal and/or resource data and the current schedules for requested personal and/or resource data can be implemented to include at least one of conflicting requests, out of office conditions, outside of working time conditions, local holiday conditions, and scheduled downtime of equipment conditions.

The invention can be implemented to realize one or more of the following advantages.

The invention can detect and warn of time conflicts in a calendaring system, and suggest alternatives and allow the user to make choices and changes to the data.

The invention can be used in conjunction with a calendaring system and enters the scene after the user types new scheduling information in the calendaring system form/screen, but before the data is committed.

The invention can be used in conjunction with a calendaring system for scheduling meetings, scheduling the use of equipment in a service or manufacturing environment, scheduling work assignments for workers such as teachers or field service personnel, scheduling appointments with individuals at other companies or private citizens who make their schedules available over web service interfaces.

The invention can warn the user that there is a conflict without the user having to take the additional and often-neglected step of manually checking. As data is entered in an appointment form by a user trying to schedule a meeting or a meeting room resource or other resource, the current schedules for requested resources, or people, are retrieved. The invention seeks conflict data in systems other than calendar servers, such as human resource and asset management systems.

The invention enables data from calendaring systems outside of an enterprise to be checked for conflict data.

One implementation of the invention provides all of the above advantages.

Details of one or more implementations are set forth in the description below. Other features, aspects, and advantages may be apparent from the description.

### BRIEF DESCRIPTION OF THE DRAWINGS

FIG. 1 is a block diagram of an exemplary network.

FIG. 2 is a flow diagram of a process resident in the network of FIG. 1.

Like reference numbers and designations in the various drawings indicate like

### DETAILED DESCRIPTION

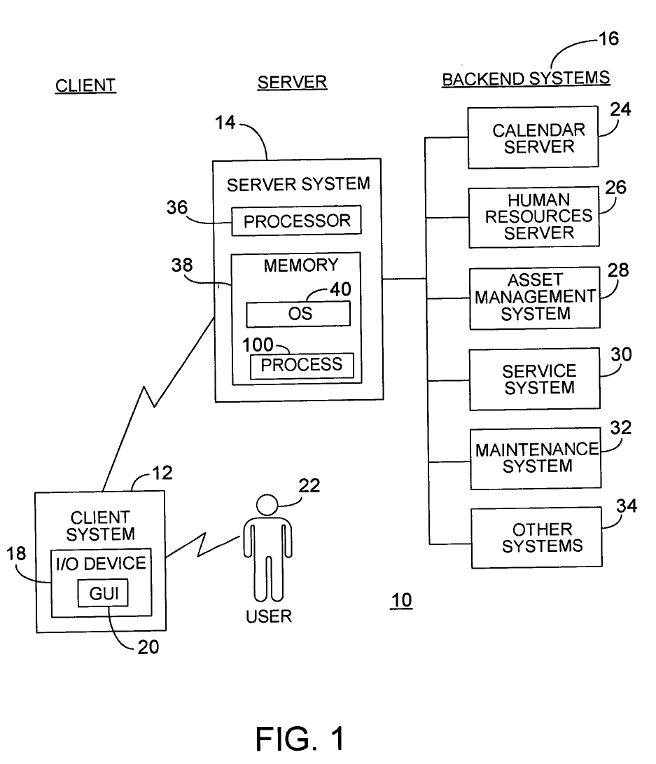

As shown in FIG. 1, an exemplary network 10 includes a client system 12, a server system 14 and back end systems 16. The client system 12 can include an input/output (I/O) device 18. The I/O device 18 can include a graphical user interface (GUI) 20 for display to a user 22.

The back end systems 16 can include one or more systems, such as a calendar server 24, human resources server 26, asset management system 28, service system 30 and/or a maintenance system 32. In one particular example, the systems 24, 26, 28, 30, 32 are part of an enterprise system. In this example, the network 10 also includes other systems 34, such as calendaring systems, residing outside of the enterprise system.

The server system 14 can include a processor 36 and memory 38. Memory 38 can include an operating system (OS) 40, such as Linux or Windows®, and a process 100 used to avoid conflicting requests for resources and/or meetings, described below.

Process 100 can be used in conjunction with calendaring systems for scheduling meetings, scheduling the use of equipment in a service or manufacturing environment, scheduling work assignments for workers such as teachers or field service personnel, scheduling appointments with individuals at other companies or private citizens who make their schedules available over web service interfaces. Process 100 warns the user 22 that there is a conflict without the user 22 having to take the additional and often-neglected step of manually checking. Using process 100, as data is entered in an appointment form by the user 22 trying to schedule a meeting or a meeting room resource or other resource, current schedules for requested resources, or people, can be retrieved, from systems residing within an enterprise system and/or systems external to the enterprise system. Process 100 seeks conflict data in systems other than calendar servers, such as human resource and asset management systems, within an enterprise, and other systems external to the enterprise, such as external calendaring systems.

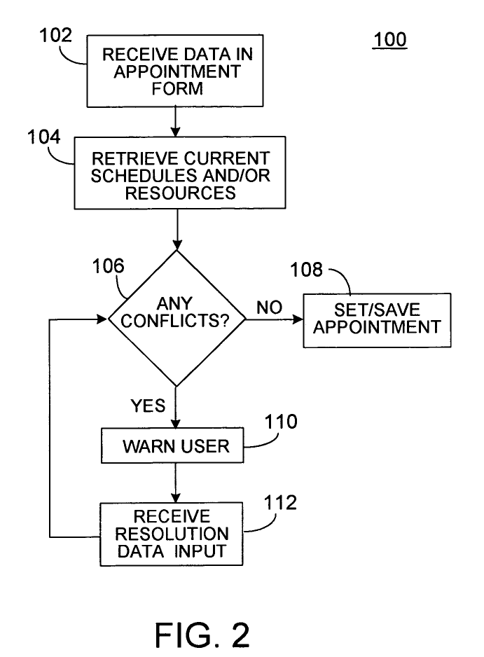

As shown in FIG. 2, process 100 includes receiving (102) data in an appointment form displayed to the user 22 on the GUI 20. In response to receiving (102), process 100 retrieves (104) data showing an availability of resources and/or people. The data is retrieved (104) from one or more back end systems 16. Access to each back end system can be through an application programming interface (API) call, a remote API call, a web service, or other appropriate interface. An API is specific method prescribed by a computer operating system or by an application program by which a programmer writing an application program can make requests of the operating system or another application. A web service is an entity that can exchange documents or information with the outside world; this entity is self-descriptive and possesses a unique identity.

The data showing the availability of resources and people can be obtained through multiple back end systems 16 including a calendar server, a human resources system, an asset management system, a service or maintenance system, personal calendaring systems outside the enterprise, or other systems internal and/or external to the enterprise.

Process 100 determines (106) whether any conflict is detected from the user entered data and the data retrieved from the back end systems 16. If no conflict is detected (106), process 100 sets/saves (108) the user entered data.

If a conflict is detected (106), process 100 generates (110) a warning indication that is optionally displayed for the user 22. Example conflicts can be conflicting requests, “out of office” conditions, “outside of working time” conditions, “local holiday” conditions, “scheduled downtime of equipment” conditions, or others. In different examples, the warning can be displayed in a GUI window's status area, as a warning icon in an appointment window, as a pop-up dialog describing the conflict, as a pop-up dialog describing the conflict and offering options for resolving the conflict and offering to automatically make changes necessary to resolve the conflict, as a highlight to the data showing where the conflict is (e.g., highlight the person or resource with the conflict, or highlight the date/time), in the window's title bar, or with another visual or auditory indication. In a particular example, the user 22 can set preferences for how this conflict indication is presented. The user 22 can set preferences for when the conflict should be detected, either as soon as it occurs or upon attempting to save an appointment. The latter is advantageous, because detecting only on attempted saving can improve the system performance.

In one implementation, before a meeting is saved, or at the time the data is entered that would cause a conflict, process 100 warns (110) the user 22 that there is a conflict, optionally offering to correct the data automatically to remove the conflict.

Process 100 can be implemented as part of a calendaring software application or as a plug-in component to a calendaring software application.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., a data server), a middleware component (e.g., an application server), and a front-end component (e.g., a client computer having a graphical user interface or a Web browser through which a user can interact with an implementation of the systems and techniques described here), or any combination of such back end, middleware, or front-end components. The components of the system can be interconnected by any form or medium of digital data communication (e.g., a communication network). Examples of communication networks include a local area network (“LAN”), a wide area network (“WAN”), a personal area network (“PAN”), a mobile communication network, and/or the Internet.

The computing system can include clients and servers. A client and server are generally remote from each other and typically interact through a communication network. The relationship of client and server arises by virtue of computer programs running on the respective computers and having a client-server relationship to each other.

Although only a few embodiments have been described in detail above, other modifications are possible. Actions do not require the particular order described, or sequential order, to achieve desirable results. In certain implementations, multitasking and parallel processing may be advantageous.

What is claimed is:

1. A computer-implemented method comprising:
receiving personal and/or resource data in a meeting appointment form presented by a system;
retrieving current schedules for the received personal and/or resource data residing in back end systems ; and
generating a warning if the received personal and/or resource data conflicts with the current schedules for requested personal and/or resource data.

2. The computer-implemented method of claim 1 wherein the form is displayed on a graphical user interface (GUI).

3. The computer-implemented method of claim 1 wherein back end systems are implemented to include at least one of a calendar server, human resource server, asset management system, service system and maintenance system.

4. The computer-implemented method of claim 1 wherein the warning is implemented to include at least one of a window's status area, a warning icon in the form, a pop-up dialogue describing the conflict, a pop-up dialogue describing the conflict and offering options for resolving the conflict and offering to automatically make changes necessary to resolve the conflict, a highlight to the received personal and/or resource data showing where the conflict is, a window's title bar, an audio indication and a visual indication.

5. The computer-implemented method of claim 1 wherein a form of the warning is user-selected.

6. The computer-implemented method of claim 1 wherein retrieving current schedules comprises an application programming interface (API) call.

7. The computer-implemented method of claim 1 wherein retrieving current schedules comprises a web interface.

8. The computer-implemented method of claim 1 wherein a conflict between the received personal and/or resource data and the current schedules for requested personal and/or resource data is implemented to include at least one of conflicting requests, out of office conditions, outside of working time conditions, local holiday conditions, and scheduled downtime of equipment conditions.

9. A computer program product, tangibly embodied in an information carrier, for avoiding scheduling conflicts in resource reservations and meeting reservations, the computer program product being operable to cause data processing apparatus to:
receive personal and/or resource data in a meeting appointment form presented by a system;
retrieve current schedules for the received personal and/or resource data residing in back end systems; and
generate a warning if the received personal and/or resource data conflicts with the current schedules for requested personal and/or resource data.

10. The computer program product of claim 9 wherein the form is displayed on a graphical user interface (GUI).

11. The computer program product of claim 9 wherein back end systems are implemented to include at least one of a calendar server, human resource server, asset management system, service system and maintenance system.

12. The computer program product of claim 9 wherein the warning is implemented to include at least one of a window's status area, a warning icon in the form, a pop-up dialogue describing the conflict, a pop-up dialogue describing the conflict and offering options for resolving the conflict and offering to automatically make changes necessary to resolve the conflict, a highlight to the received personal and/or resource data showing where the conflict is, a window's title bar, an audio indication and a visual indication.

13. The computer program product of claim 9 wherein a form of the warning is user-selected.

14. The computer program product of claim 9 wherein retrieving current schedules comprises an application programming interface (API) call.

15. The computer program product of claim 9 wherein retrieving current schedules comprises a web interface.

16. The computer program product of claim 9 wherein a conflict between the received personal and/or resource data and the current schedules for requested personal and/or resource data is implemented to include at least one of conflicting requests, out of office conditions, outside of working time conditions, local holiday conditions, and scheduled downtime of equipment conditions.
